(19) United States
(12) Patent Application Publication
(10) Pub. No.: US 2004/0148989 A1
(43) Pub. Date: Aug. 5, 2004

(54) Key for locks

(76) Inventor: Hui-Hua Hsieh, Chung Ho City (TW)

Correspondence Address: Hui-Hua Hsieh, P.O. Box 90, Tainan City, 704, TW

(21) Appl. No.: 10/356,510

(22) Filed: Feb. 3, 2003

(51) Int. Cl. E05B 19/06

(52) U.S. Cl. 70/409

(57) ABSTRACT

A key for locks in the invention mainly has a key body provided with at least two pivot lugs disposed at one end thereof. Each of the pivot lugs has a through hole and can be pivoted with an insert member by a pivot member. Each of the insert members has an opening slot disposed at one end thereof, a through hole penetrating through the opening slot and at least one engagement hole disposed therein. Every two of the insert members can be engaged by an elastic member. When the key is inserted into a keyhole of a lock core of a lock, the insert members of the key body will be extended into the keyhole of the lock core to rotate the lock core to open the lock, thus achieving an effect of actually preventing the lock from being unlocked illegally by a general key.

### BACKGROUND OF THE INVENTION

1. Field of the Invention

This invention relates to a key for locks, particularly to one having a key body provided with at least two pivot lugs disposed at one end thereof, each of the pivot lugs provided with a through hole and capable of being pivoted with an insert member by a pivot member, each of the insert members provided with an opening slot disposed at one end thereof, a through hole penetrating through the opening slot and at least one engagement hole disposed therein, every two of the insert members capable of being engaged by an elastic member, by which when the key is inserted into a keyhole of a lock core of a lock, the insert members of the key body will be extended into the keyhole of the lock core to rotate the lock core to open the lock, thus achieving an effect of actually preventing the lock from being unlocked illegally by a general key.

2. Description of the Prior Art

Generally speaking, as shown in FIG. 1, a known conventional key 1 mainly has a key body 10 provided with a plurality of dimples 11 disposed therein. A grip head 12 is mounted to one end of the key body 10. A general lock that is designed for the known key 1 (not shown) is provided with a plurality of locking pins disposed therein for being matched with the plurality of dimples 11 of the known key 1. However, such known key 1 is very easy to be reproduced illegally, thus having a bad effect of anti-theft.

### SUMMARY OF THE INVENTION

The main purpose of the invention is to offer a key for locks having an excellent effect of anti-theft.

The main feature of the invention is to provide a key for locks having a key body provided with at least two pivot lugs disposed at one end thereof, each of the pivot lugs provided with a through hole and capable of being pivoted with an insert member by a pivot member, each of the insert members provided with an opening slot disposed at one end thereof, a through hole penetrating through the opening slot and at least one engagement hole disposed therein, every two of the insert members capable of being engaged by an elastic member.

### BRIEF DESCRIPTION OF DRAWINGS

This invention will be better understood by referring to the accompanying drawings, wherein:

FIG. 1 is a perspective view of a known conventional key;

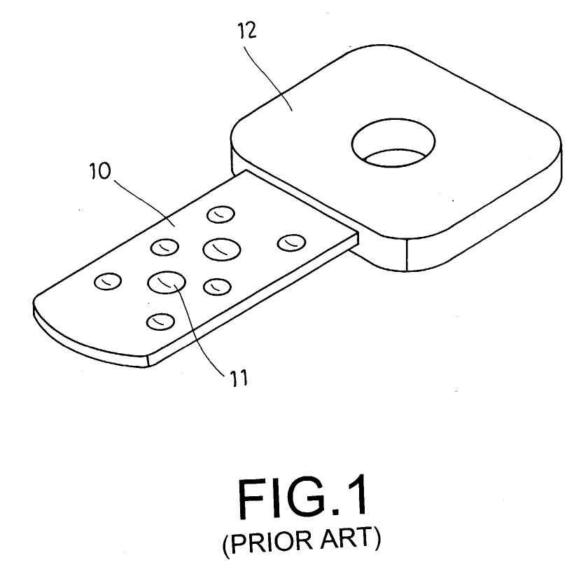

FIG. 2 is an exploded perspective view of a key for locks in the present invention;

FIG. 3 is a perspective view showing an assemblage of the key for locks in the present invention; and,

FIG. 4 is a schematic view of the key for locks in the present invention in use.

### DETAILED DESCRIPTION OF THE PREFERRED EMBODIMENT

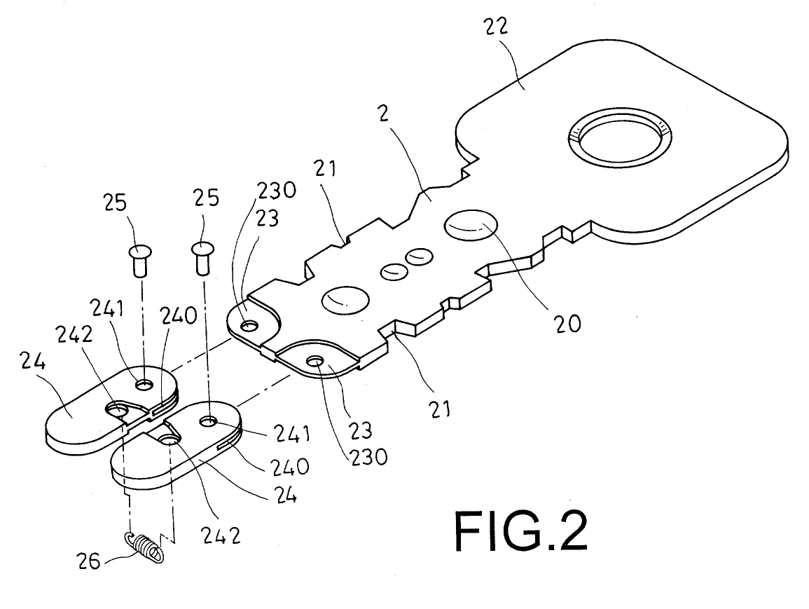

A preferred embodiment of a key for locks in the present invention, as shown in FIG. 2, mainly has a key body 2 provided with a plurality of dimples 20 of different sizes oppositely disposed in an upper and a lower surfaces thereof, a plurality of grooves 21 of different sizes oppositely disposed at both sides thereof, and a grip head 22 disposed at one end thereof. The key body 2 further has two pivot lugs 23 disposed at the other end thereof. Each of the two pivot lugs 23 is provided with a through hole 230 and capable of being pivoted with an insert member 24 by a pivot member 25. Each of the two insert members 24 is provided with an opening slot 240 disposed at one end thereof, a through hole 241 penetrating through the opening slot 240 and an engagement hole 242 disposed at one side thereof. The two engagement holes 242 of the two insert members 24 are respectively disposed at opposite sides of the two insert members 24. An elastic member 26 is capable of being engaged between the two insert members 24.

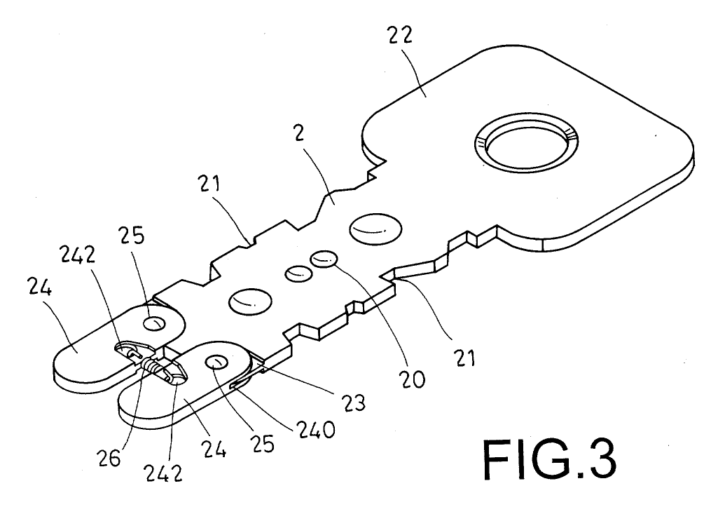

In assembling, referring to FIGS. 2 and 3, firstly join the two insert members 24 respectively together with the two pivot lugs 23 of the key body 2 by having the two through holes 241 of the two insert members 24 respectively aligned with the two through holes 230 of the two pivot lugs 23, and having two pivot members 25 respectively extended through the through holes 241, 230 of the two insert members 24 and the two pivot lugs 23 so as to have the two insert members 24 pivoted with the two pivot lugs 23. And then, engage the elastic member 26 between the two insert members 24 by having both ends of the elastic member 26 respectively hooked in the two engagement holes 242 of the two insert members 24, by which an assemblage of the whole structure of the key in the present invention is completed.

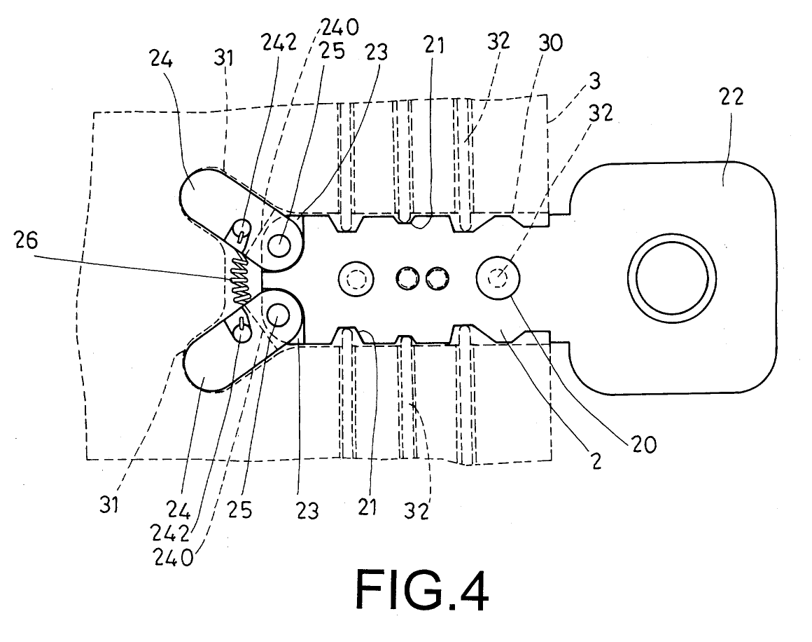

In using, referring to FIGS. 3 and 4, firstly insert the key body 2 into a keyhole 30 of a lock core 3 of a lock especially designed for the key body 2 to make the two insert members 24 respectively engaged in two recesses 31 of the keyhole 30, by which the two insert members 24 will be pushed forward along beveled inner surfaces of the two recesses 31 and expanded outwardly to make the elastic member 26 pulled outwardly accordingly to be in an elastic stretched status. At the same time, in the forwarding process of the key, the both sides of the key body 2 will be pressed against a plurality of locking pins 32 disposed at both sides of the keyhole 3 to make the plurality of locking pins 32 respectively engaged in the grooves 21 of the key body 2; the upper and the lower surfaces of the key body 2 will also be pressed against another plurality of locking pins 32 disposed at an upper and a lower surfaces of the keyhole 3 to make the another plurality of locking pins 32 respectively engaged in the dimples 21 of the key body 2. Therefore, an engagement of the two insert members 24 respectively in the two recesses 31 of the keyhole 30 enables the key body 2 to be positioned in place with the plurality of dimples 20 and grooves 21 of the key body 2 respectively engaged by the plurality of locking pins 32 and the another plurality of locking pins 32 of the keyhole 30 to make the lock core 3 in an unlocked status so that the lock core 3 can be rotated to open the lock. After the lock is open, pull the key body 2 out of the keyhole 30, by which the two insert members 24 will be pulled back close to each other under the resilience of the elastic member 26. Therefore, except the key of the present invention, it is impossible for a general key to open the lock that is especially designed for the key body 2 of the key, thus preventing the lock from being unlocked illegally by a general key so as to achieve a real effect of anti-theft.

While the preferred embodiment of the invention has been described above, it will be recognized and understood that various modifications may be made therein and the appended claims are intended to cover all such modifications that may fall within the spirit and scope of the invention.

What is claimed is:

1. A key for locks comprising:
a key body having a plurality of dimples of different sizes respectively disposed in an upper and a lower surfaces thereof, a plurality of grooves respectively disposed at both sides thereof, and a grip head disposed at one end thereof; and,
characterized by said key body further having at least two pivot lugs disposed at the other end thereof and each provided with a through hole, each said pivot lug capable of being pivoted with an insert member by a pivot member, each said insert member provided with an opening slot disposed at one end thereof, a through hole penetrating through said opening slot and at least one engagement hole disposed therein, every two said insert members capable of being engaged by an elastic member; and,
whereby when said key is inserted into a keyhole of a lock core of a lock, said insert members of said key body will be extended into said keyhole of said lock core to rotate said lock core to open said lock, thus achieving an effect of actually preventing said lock from being unlocked illegally by a general key.
